(19) United States
(12) Patent Application Publication
(10) Pub. No.: US 2025/0392869 A1
(43) Pub. Date: Dec. 25, 2025

(54) METHOD FOR DETERMINING TARGET SOUND EFFECT PARAMETER

(71) Applicant: AAC Technologies (Nanjing) Co., Ltd., Nanjing (CN)

(72) Inventors: Xin Zhang, Shenzhen (CN); Shuyuan Sun, Shenzhen (CN)

(21) Appl. No.: 19/308,217

(22) Filed: Aug. 23, 2025

Related U.S. Application Data
(63) Continuation of application No. 18/095,004, filed on Jan. 10, 2023, now abandoned.
Application No. 18/095,004 is a continuation of application No. PCT/CN2022/129712, filed on Nov. 4, 2022.

(30) Foreign Application Priority Data
Sep. 27, 2022 (CN) 202211181449.3

(51) Int. Cl. H04R 5/04; H04R 29/00

(52) U.S. Cl. CPC H04R 5/04; H04R 29/001; H04R 2420/05

(57) ABSTRACT

The method for determining sound channels is provided according to the embodiments of the present disclosure, the method includes: determining a number of speakers according to obtained output current and obtained output voltage; determining a system channel according to the number of speakers; determining a target sound effect parameter according to the number of speakers and the system channel, so that the multiple manufacturers can realize the high configuration, the medium configuration or the low configuration of the computer device by providing different number of speakers without setting sound effect parameter for computer device of each model, which reduces the design cost of the multiple manufacturer developing speaker systems, and saves manpower and research and development resources.

### CROSS REFERENCE TO RELATED APPLICATIONS

This application is a continuation of U.S. patent application Ser. No. 18/095,004, filed Jan. 10, 2023, titled “METHOD FOR DETERMINING SOUND CHANNELS, DEVICE FOR DETERMINING SOUND CHANNELS, AND STORAGE MEDIUM”, which is a continuation of PCT Patent Application No. PCT/CN2022/129712, entitled “METHOD FOR DETERMINING SOUND CHANNELS, DEVICE FOR DETERMINING SOUND CHANNELS, AND STORAGE MEDIUM,” filed MONTH DAY, YEAR, which claims priority to Chinese patent application No. 202211181449.3, entitled “METHOD FOR DETERMINING SOUND CHANNELS, DEVICE FOR DETERMINING SOUND CHANNELS, STORAGE MEDIUM, AND COMPUTER DEVICE,” filed Sep. 27, 2022. The entire contents of these applications are incorporated by reference herein in their entirely and relied upon.

### TECHNICAL FIELD

The embodiment of the present disclosure relates to the technical field of smart home, in particular to a method for determining sound channels, a device for determining sound channels, a storage medium, and a computer device.

### BACKGROUND

With the rapid development of smart devices, requirements of a consumer for the sound quality of a smart TV are gradually increased. In the current smart TV market, TV products of each of multiple manufacturers will be divided into high configuration smart TVs, medium configuration smart TVs or low configuration smart TVs according to different prices. Among them, speaker configurations of high configuration smart TVs, medium configuration smart TVs or low configuration smart TVs are different. And only high configuration smart TVs of part of the multiple manufacturers are equipped with a speaker system with a 5.1.2 channel and above, and surround sound effects.

Each of the multiple manufacturers need to design different hardware systems and speaker systems according to different product designs, resulting in many smart TV models every year. Due to different sound effects, each model needs to invest a lot of manpower and research and development resources, increasing the design cost of each of the multiple manufacturers to develop speaker systems.

### SUMMARY

In view of this, a method for determining sound channels, a device for determining sound channels, a storage medium, and a computer device are provided according to embodiments of the present disclosure, to solve a problem that the design cost of speaker systems developed by multiple manufacturers in the conventional art is increased.

In a first aspect, a method for determining sound channels is provided according to embodiments of the present disclosure, the method includes:
determining a number of speakers according to obtained output current and obtained output voltage;
determining a system channel according to the number of speakers;
determining a target sound effect parameter according to the number of speakers and the system channel.

As an improvement, determining the number of speakers according to the obtained output current and the obtained output voltage includes:
generating at least one load resistance value according to the obtained output current and the obtained output voltage;
determining the number of speakers according to the at least one load resistance value.

As an improvement, determining the system channel according to the number of speakers includes:
determining the system channel according to the number of speakers and obtained first channel.

As an improvement, the target sound effect parameter comprises at least one of a voice equalizing parameter, an automatic linear distortion compensation parameter, a bass enhancement parameter, a stereo expansion parameter, and a dynamic range control parameter.

As an improvement, the system channel includes at least one of a 2.0 channel, a 2.1 channel, a 4.0 channel, a 4.1 channel, a 5.1 channel, a 5.1.2 channel, a 7.1 channel and a 7.1.4 channel.

As an improvement, determining the target sound effect parameter according to the number of speakers and the system channel includes:
searching at least one sound effect parameter according to the number of speakers and the system channel;
determining the target sound effect parameter from the at least one sound effect parameter according to a priority of the at least one sound effect parameter.

In a second aspect, a device for determining sound channels is provided according to embodiments of the present disclosure, the device includes:
a first determining module, configured to determine a number of speakers according to obtained output current and obtained output voltage;
a second determining module, configured to determine a system channel according to the number of speakers;
a third determining module, configured to determine a target sound effect parameter according to the number of speakers and the system channel.

As an improvement, the first determining module comprises a generating submodule and a determining submodule;
the generating submodule is configured to generate at least one load resistance value according to the obtained output current and the obtained output voltage;
the determining submodule is configured to determine the number of speakers according to the at least one load resistance value.

In a third aspect, a storage medium is provided according to embodiments of the present disclosure, the storage medium includes a program stored therein, where the program, when executed, control a device in which the storage medium is located to execute the method for determining sound channel according to the above first aspect or any possible implementation of the first aspect.

In a fourth aspect, a computer device is provided according to embodiments of the present disclosure, the computer device includes a memory and a processor, where the memory is configured to store information comprising program instructions, and the processor is configured to execute the program instructions, and the program instructions, when loaded and executed by the processor, cause the method for determining sound channel according to the above first aspect or any possible implementation of the first aspect to be implemented.

In the technical solutions of the method for determining sound channels, the device for determining sound channels, the storage medium, and the computer device provided according to the embodiments of the present disclosure, the number of speakers is determined according to the obtained output current and the obtained output voltage, the system channel is determined according to the number of speakers, and the target sound effect parameter is determined according to the number of speakers and the system channel, so that the multiple manufacturers can realize the high configuration, the medium configuration or the low configuration of the computer device by providing different number of speakers without setting sound effect parameter for computer device of each model, which reduces the design cost of the multiple manufacturer developing speaker systems, and saves manpower and research and development resources.

### BRIEF DESCRIPTION OF THE DRAWINGS

For more clearly illustrating embodiments of the present disclosure or the technical solutions in the conventional technology, drawings referred to for describing the embodiments or the conventional technology will be briefly described hereinafter. Apparently, drawings in the following description are only examples of the present disclosure, and for the person skilled in the art, other drawings may be acquired based on the provided drawings without any creative efforts.

FIG. 1 is a flow chart of a method for determining sound channels provided according to an embodiment of the present disclosure;

FIG. 2 is a schematic view of an intelligent detection module provided according to an embodiment of the present disclosure;

FIG. 3 is a schematic view of a parameter matching module provided according to an embodiment of the present disclosure;

FIG. 4 is a flow chart of another method for determining sound channels provided according to an embodiment of the present disclosure;

FIG. 5 is the schematic structural view of a device for determining sound channels provided according to an embodiment of the present disclosure;

FIG. 6 is a schematic view of a computer device provided according to an embodiment of the present disclosure.

### DETAILED DESCRIPTION

In order to better understand the technical solution of the present disclosure, the embodiments of the present disclosure are described in detail below in combination with the accompanying drawings.

It is apparent that the described embodiments are only a part of the embodiments according to the present disclosure, rather than all of the embodiments. Based on the embodiments of the present disclosure, all other embodiments obtained without creative efforts by those of ordinary skill in the art shall fall within the protection scope of the present disclosure.

The terms used in the embodiments of the present disclosure are only for the purpose of describing specific embodiments, and are not intended to limit the present disclosure. The singular forms of “one”, “said” and “the” used in the embodiments of the present disclosure and the appended claims are also intended to include the majority forms, unless the context clearly indicates other meanings.

It should be understood that the term “and/or” used in this paper is only a kind of association relationship to describe association objects, indicating that there can be three kinds of relationships, for example, A and/or B, which can indicate that there are three cases: A alone, A and B together, and B alone. In addition, the character “/” in this article generally indicates that the context object is an “or” relationship.

It should be understood that although the terms first, second, third, etc. may be used to describe numbers and the like in embodiments of the present disclosure, these numbers should not be limited to these terms. These terms are used only to distinguish numbers from each other. For example, without departing from the scope of embodiments of the present disclosure, a first number can also be referred to as a second number, and similarly, the second number can also be called the first number.

Depending on the context, the wording “if” as used here can be interpreted as “when” or “while” or “in response to determining” or “in response to detecting”. Similarly, depending on the context, the phrase “if determining” or “if detecting (stated condition or event)” can be interpreted as “when determining” or “in response to determining” or “when detecting (stated condition or event)” or “in response to detecting (stated condition or event)”.

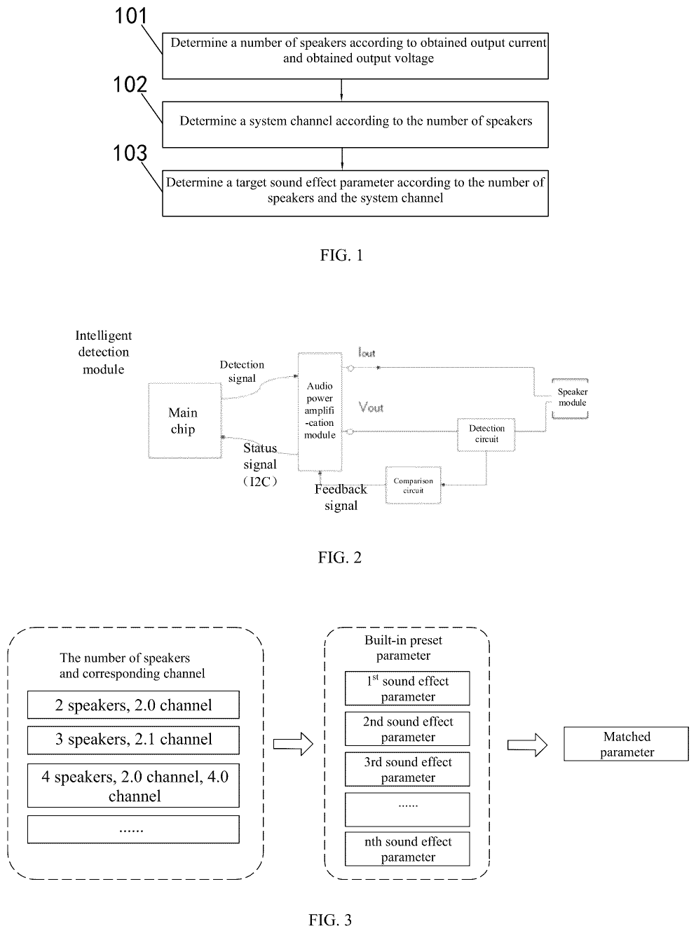

FIG. 1 is a flowchart of a method for determining sound channels provided according to an embodiment of the present disclosure, as shown in FIG. 1. The method includes the following operations.

In operation 101, a number of speakers is determined according to obtained output current and obtained output voltage.

Each operation of the embodiments of the present disclosure can be performed by a computer device. The computer device includes but is not limited to a smart TV, an external device of the smart TV or, the smart TV and the external device.

In the embodiments of the present disclosure, FIG. 2 is a schematic view of an intelligent detection module provided according to the embodiment of the present disclosure. As shown in FIG. 2, the intelligent detection module shown in FIG. 2 is mounted on a computer device, and the intelligent detection module includes a main chip, an audio power amplification module, a speaker module, a detection circuit and a comparison circuit. The main chip is connected to the audio power amplifier module, the audio power amplifier module is connected to the speaker module and the detection circuit, the speaker module is connected to the detection circuit, the detection circuit is connected to the comparison circuit, and the comparison circuit is connected to the audio power amplifier module.

An output end of the audio power amplifier module is configured to send output current (Iₒᵤₜ) to the speaker module, send output voltage (Vₒᵤₜ) to the detection circuit and the speaker module. The comparison circuit is configured to send feedback signals to the audio power amplifier module. The computer device is configured to obtain the output current and the output voltage, and determine the number of speakers according to the output current and the output voltage.

In operation 102, the system channel is determined according to the number of speakers.

In the embodiment of the present disclosure, the system channel includes at least one of a 2.0 channel, a 2.1 channel, a 4.0 channel, a 4.1 channel, a 5.1 channel, a 5.1.2 channel, a 7.1 channel, and a 7.1.4 channel.

In operation 103, the target sound effect parameter is determined according to the number of speakers and the system channel.

In the embodiments of the present disclosure, FIG. 3 is a schematic view of a parameter matching module provided according to the embodiment of the present disclosure. As shown in FIG. 3, the parameter matching module shown in FIG. 3 is mounted on the computer device, and multiple sound effect parameters are stored in the parameter matching module in advance. The computer device is configured to determine the target sound effect parameter from the multiple sound effect parameters according to the number of speakers and the system channel.

The method for determining sound channels is provided according to the embodiments of the present disclosure. The number of speakers is determined according to the obtained output current and the obtained output voltage, the system channel is determined according to the number of speakers, and the target sound effect parameter is determined according to the number of speakers and the system channel. Since high configuration computer device, medium configuration computer device, and low configuration computer correspond to different sound effect parameters, respectively, after the number of speakers is determined by the computer device, the sound effect parameter of the computer device is determined according to the number of speakers, to realize the high configuration, the medium configuration or the low configuration of the computer device, so that it is not necessary for the multiple manufacturers to develop the speaker systems many times, which reduces the design cost of the multiple manufacturer developing speaker systems, and saves manpower and research and development resources.

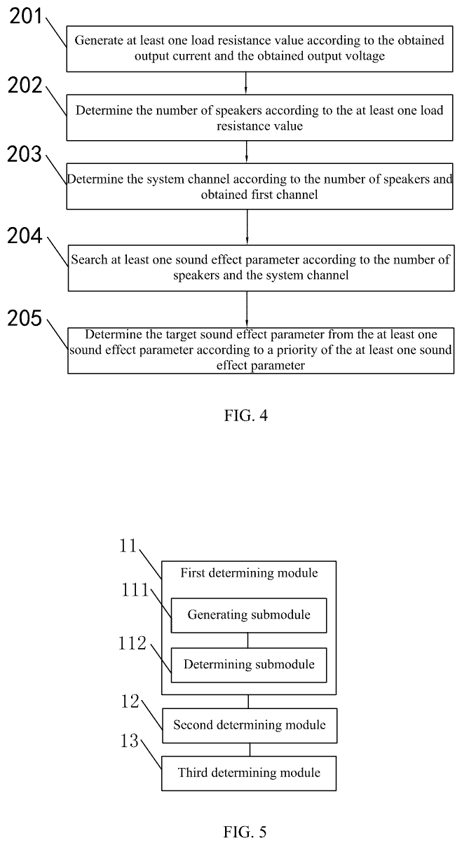

FIG. 4 is a flow chart of another method for determining sound channels provided according to an embodiment of the present disclosure, as shown in FIG. 4. The method includes the following operations.

In operation 201, at least one load resistance value is generated according to the obtained output current and the obtained output voltage.

In the embodiments of the present disclosure, as shown in FIG. 2, the output end of the main chip is configured to send detection signal to the audio power amplifier module. The input end of the audio power amplifier module is configured to receive the detection signal sent by the main chip, the output end of the audio power amplifier module is configured to send the output voltage to the speaker module and the detection circuit, and send the output current to the speaker module. The input end of the speaker module is configured to receive the output current sent by the audio power amplifier module, and the output end of the speaker module is configured to send the output current to the detection circuit, so that the detection circuit in the loop can identify the output current by itself. The detection circuit is configured to send the detected output current to the comparison circuit. The comparison circuit includes multiple detection circuits. Each of the multiple detection circuits is configured to verify the output current, and is connected to a speaker in the speaker module to obtain the impedance value of each speaker in the speaker module.

In operation 202, the number of speakers is determined according to the at least one load resistance value.

In the embodiment of the present disclosure, the computer device counts the effective number of at least one load resistance value within an effective threshold value range according to the at least one load resistance value and the effective threshold value range, and the effective number is taken as the number of speakers.

As shown in FIG. 2, the comparison circuit is configured to send feedback signal to the audio power amplifier module. The feedback signal includes at least one load resistance value, and the audio power amplifier module is configured to filter out at least one load resistance value within the effective threshold value range. The audio power amplifier module is configured to send a status signal to the main chip. The status signal includes at least one load resistance value within the effective threshold value range. The main chip is configured to count the effective number of load resistance values within the effective threshold value range as the number of speakers. For example, since the resistance value of the speaker is generally greater than or equal to 2Ω and less than or equal to 32Ω, in response to the load resistance value being greater than 32Ω, it indicates that the output end of the audio power amplifier module is an open circuit. In response to the load resistance being greater than or equal to 2Ω and less than or equal to 32Ω, it indicates that the speaker module includes at least one speaker. In response to the load resistance being less than 2Ω, it indicates that the speaker module is in a short circuit state. Therefore, the effective threshold value range can be a range where the load resistance value is greater than or equal to 2Ω and less than or equal to 32Ω. In response to the status signal received by the main chip including 4 load resistance values greater than or equal to 2Ω and less than or equal to 32Ω, it indicates that the computer device includes four speakers.

In operation 203, the system channel is determined according to the number of speakers and the obtained first channel.

In the embodiments of the present disclosure, the first channel is the channel of a preset speaker. The determined system channel is the channel that can be used by the computer device. The first channel includes at least one of a 2.0 channel, a 2.1 channel, a 4.0 channel, a 4.1 channel, a 5.1 channel, a 5.1.2 channel, a 7.1 channel and a 7.1.4 channel. As shown in FIG. 3, the first channel is stored in the computer device, and the system channel is determined by the computer device from the first channel according to the number of speakers. In response to the computer device only including two speakers, the system channel is the 2.0 channel, in response to the computer device including four speakers, the system channels are the 2.0 channel and the 4.0 channel.

In operation 204, at least one sound effect parameter is searched according to the number of speakers and the system channel.

In the embodiments of the present disclosure, the target sound effect parameter include at least one of a voice equalizer parameter, an automatic linear distortion compensation parameter, a bass enhancement parameter, a stereo expansion parameter, and a dynamic range control parameter.

Multiple sound effect parameters are stored in the computer device. Each of the multiple sound effect parameters is debugged according to the number of speakers and the system channels to ensure the optimal sound quality of speakers under the number of speakers and the system channel. The computer device includes a digital signal processing (DSP) chip, and the staff can add the number of speakers, a corresponding relationship between the system channel and the target sound effect parameter to the DSP chip in advance. The computer device is configured to search at least one sound effect parameter according to the corresponding relationship between the system channel and the target sound effect parameter. As shown in FIG. 3, in response to the number of speakers being 4 and the system channel being the 2.0 channel and the 4.0 channel, the sound effect parameters corresponding to four speakers and the 2.0 channel are searched, and the sound effect parameters corresponding to four speakers and the 4.0 channel are searched.

In operation step 205, the target sound effect parameter is determined from the at least one sound effect parameter according to a priority of the sound effect parameters.

In the embodiments of the present disclosure, the priority of sound effect parameters is stored in the computer device in advance. The priority of sound effect parameters is determined according to the output sound quality. For example, as shown in FIG. 3, the sound effect parameters corresponding to four speakers and the 2.0 channel, and the sound effect parameters corresponding to four speakers and the 4.0 channel are searched by the computer device. However, the sound quality of the sound outputted by the computer device according to the sound effect parameters corresponding to the four speakers and the 4.0 channel is higher than that of the sound outputted by the computer device according to the sound effect parameters corresponding to the four speakers and the 2.0 channel. Therefore, the priority of the sound effect parameters corresponding to the four speakers and the 4.0 channel is higher than that of the sound effect parameters corresponding to the four speakers and the 2.0 channel. The computer device is configured to determine the target sound effect parameter as the sound effect parameters corresponding to four speakers and the 4.0 channel.

The computer device plays the sound according to the determined target sound effect parameters, so that the computer device can output the optimal sound effect and achieve the optimal sound effect. In addition, in response to the user's requirements for sound quality increasing, the user does not need to replace the computer device or the speaker system of the computer device to meet the requirements for sound quality. The computer device can determine better sound effect parameters by increasing the number of speakers of the computer device.

The method for determining sound channels is provided according to the embodiments of the present disclosure. The number of speakers is determined according to the obtained output current and the obtained output voltage, the system channel is determined according to the number of speakers, and the target sound effect parameter is determined according to the number of speakers and the system channel, so that the high configuration, the medium configuration or the low configuration of the computer device can be achieved by configuring different number of speakers, which reduces the design cost of manufacturers to develop speaker systems, increases the scalability of sound playback, thereby improving product differentiation. In addition, it is not necessary to set the sound effect parameters for each model of computer device, which saves manpower and research and development resources, and increases the possibility and convenience for users to conduct personalized upgrading of speaker system in the later period, so that users can also meet the pursuit of sound quality without replacing the computer device or the speaker system.

FIG. 5 is the schematic structural view of a device for determining sound channels provided according to an embodiment of the present disclosure. As shown in FIG. 5, the device includes a first determining module 11, a second determining module 12 and a third determining module 13.

The first determining module 11 is configured to determine the number of speakers according to the obtained output current and the obtained output voltage, the second determining module 12 is configured to determine the system channel according to the number of speakers, and the third determining module 13 is configured to determine the target sound effect parameter according to the number of speakers and the system channel.

In the embodiments of the present disclosure, the first determining module 11 includes a generating submodule 111 and a determining submodule 112.

The generating submodule 111 is configured to generate at least one load resistance value according to the obtained output current and the obtained output voltage, and the determining submodule 112 is configured to determine the number of speakers according to the at least one load resistance value.

In the embodiments of the present disclosure, the second determining module 12 is specifically configured to determine the system channel according to the number of speakers and the obtained first channel.

In the embodiments of the present disclosure, the target sound effect parameter includes at least one of a voice equalizer parameter, an automatic linear distortion compensation parameter, a bass enhancement parameter, a stereo expansion parameter, and a dynamic range control parameter.

In the embodiments of the present disclosure, the system channel includes at least one of a 2.0 channel, a 2.1 channel, a 4.0 channel, a 4.1 channel, a 5.1 channel, a 5.1.2 channel, a 7.1 channel and a 7.1.4 channel.

In the embodiments of the present disclosure, the third determining module 13 is specifically configured to search at least one sound effect parameter according to the number of speakers and the system channel, and determine the target sound effect parameter from the at least one sound effect parameter according to the priority of sound effect parameters.

The device for determining sound channels is provided according to the embodiments of the present disclosure. The number of speakers is determined according to the obtained output current and the obtained output voltage, the system channel is determined according to the number of speakers, and the target sound effect parameter is determined according to the number of speakers and the system channel, so that the high configuration, the medium configuration or the low configuration of the computer device can be achieved by configuring different number of speakers, which reduces the design cost of manufacturers to develop speaker systems, increases the scalability of sound playback, thereby improving product differentiation. In addition, it is not necessary to set the sound effect parameters for each model of computer device, which saves manpower and research and development resources, and increases the possibility and convenience for users to conduct personalized upgrading of speaker system in the later period, so that users can also meet the pursuit of sound quality without replacing the computer device or the speaker system.

A storage medium is provided according to embodiments of the present disclosure, the storage medium includes a program stored therein, where the program, when executed, control a device in which the storage medium is located to execute each operation in the above method for determining sound channel, reference is made above embodiments of the method for determining sound channel for detailed descriptions.

A computer device is provided according to embodiments of the present disclosure, the computer device includes a memory and a processor, where the memory is configured to store information comprising program instructions, and the processor is configured to execute the program instructions, and the program instructions, when loaded and executed by the processor, cause each operation in the above method for determining sound channel to be implemented, reference is made above embodiments of the method for determining sound channel for detailed descriptions.

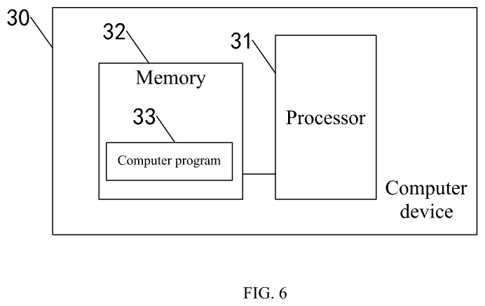

FIG. 6 is a schematic view of a computer device provided according to an embodiment of the present disclosure. As shown in FIG. 6, a computer device 30 of the embodiment includes a processor 31, a memory 32, and a computer program 33 stored in the memory 32 and processor-implementable on the processor 31. In response to the computer program 33 being executed by the processor 31, the method for determining sound channels in the embodiments is implemented, which will not be repeated herein to avoid repetition. Or, in response to the computer program being executed by the processor 31, the functions of each module/unit in the device for determining sound channels in the embodiment is implemented, which will not be repeated herein to avoid repetition.

The computer device 30 includes, but is not limited to, the processor 31 and the memory 32. Those skilled in the art can understand that FIG. 6 is only an example of the computer device 30, and does not constitute a limitation on the computer device 30. The computer device 30 may include more or fewer components than shown, or combine some components, or different components. For example, the computer device 30 may also include input and output devices, network access devices, buses, and the like.

The processor 31 may be embodied as a central processing unit (CPU), other general-purpose processors, a digital signal processor (DSP), an application specific integrated circuit (ASIC), a field programmable gate array (FPGA), or other programmable logic devices, discrete gates, transistor logic devices, or discrete hardware components, etc. A general-purpose processor may be a microprocessor or the processor may also be any conventional processor or the like.

The memory 32 may be embodied as an internal storage unit of the computer device 30, such as a hard disk or memory of the computer device 30. The memory 32 may also be an external storage device of the computer device 30, such as a plug-in hard disk, a smart media card (SMC), a secure digital (SD) card, a flash card, and the like equipped on the computer device 30. Further, the memory 32 may also include both an internal storage unit and an external storage device of the computer device 30. The memory 32 is configured to store computer programs, other programs and data required by the computer device 30. The memory 32 is further configured to temporarily store data that has been output or will be output.

Those skilled in the art can clearly understand that, for the convenience and simplicity of description, the specific working process of the above systems, devices and units can refer to the corresponding process in the above method embodiments, and will not be repeated here.

In several embodiments provided according to the present disclosure, it should be understood that the disclosed system, device and method can be implemented in other ways. For example, the device embodiments described above are only schematic, for example, the division of the unit is only a logical function division, and there can be another division method when implemented in practice. For example, multiple units or components can be combined or integrated into another system, or some features can be ignored or not implemented. On the other hand, the mutual coupling or direct coupling or communication connection shown or discussed can be indirect coupling or communication connection through some interfaces, devices, or units, and can be electrical, mechanical, or other forms.

The units described as separate units may or may not be physically separated, and the units displayed as units may or may not be physical units, that is, they may be in one place or distributed to multiple network units. Some or all the units can be selected according to actual needs to achieve the purpose of the embodiment.

In addition, each functional unit in each embodiment of the present disclosure can be integrated in a processing unit, or each unit can exist physically independently, or two or more units can be integrated in a unit. The integrated units can be implemented in the form of hardware or hardware plus software functional units.

The integrated unit in the form of software functional unit can be stored in a computer readable storage medium. The above software functional unit is stored in a storage medium, including several instructions to enable a computer device (which can be a personal computer, a server, or a network device, etc.) or a processor to perform some steps of the method described in various embodiments of the present disclosure. The storage media include: USB flash disk, mobile hard disk, read only memory (ROM), random access memory (RAM), magnetic disc or optical disc and other media that can store program codes.

The above are only the embodiments of the present disclosure. It should be pointed out that for those of ordinary skill in the art, improvements may be made without departing from the inventive concept of the present disclosure, and the improvements shall fall with the scope of protection of the present disclosure.

1. A method for determining a target sound effect parameter of a sound device, comprising steps of:
providing a plurality of speakers equipped with the sound device;
providing a computer device for storing multiple preset sound effect parameters and preset system channels;
determining an amount of the plurality of speakers of the sound device by the computer device according to an obtained output current and an obtained output voltage of the plurality of speakers;
determining a system channel of the sound device among the preset system channels by the computer device according to the amount of the plurality of speakers;
searching the multiple preset sound effect parameters for selecting at least one sound effect parameter according to the amount of the plurality of speakers and the system channel by the computer device; and
determining the target sound effect parameter from the at least one sound effect parameter according to a priority of the at least one sound effect parameter by the computer device.

2. The method as described in claim 1, wherein the step of determining the amount of the plurality of speakers according to the obtained output current and the obtained output voltage of the speakers further comprises steps of:
sending a detection signal from a main chip to an audio power amplification module;
sending an output current and an output voltage to the plurality of the speakers by the audio power amplification module according to the detection signal;
collecting the obtained output current and the obtained output voltage of each of the plurality of the speakers by a detection circuit to generate at least one load resistance value;
sending the at least one load resistance value to the audio power amplification module for matching within an effective threshold value range;
determining the amount of the plurality of speakers according to the number of load resistance values within the effective threshold value range by the main chip.

3. The method as described in claim 2, wherein the effective threshold value range is a range where a load resistance value is greater than or equal to 2Ω and less than or equal to 32Ω.

4. The method as described in claim 1, wherein each of the multiple preset sound effect parameters is debugged according to the amount of the plurality of speakers and the system channels.

5. The method as described in claim 1, wherein the step of determining the target sound effect parameter from the at least one sound effect parameter according to a priority of the at least one sound effect parameter by the computer device further comprises a step of:
storing a priority of the sound effect parameters in the computer device in advance, and determining the priority of sound effect parameters according to output sound qualities.

6. The method as described in claim 1, wherein the target sound effect parameter comprises at least one of a voice equalizing parameter, an automatic linear distortion compensation parameter, a bass enhancement parameter, a stereo expansion parameter, and a dynamic range control parameter.
